(19) United States
(12) Patent Application Publication
(10) Pub. No.: US 2026/0368646 A1
(43) Pub. Date: Nov. 19, 2026

(54) CALL TIME APPLICATION

(71) Applicant: SMART CALLTIME SOLUTIONS LLC, Richmond, KY (US)

(72) Inventors: Asa King, Louisville, KY (US); Samuel Taylor Coots, Louisville, KY (US)

(21) Appl. No.: 19/680,343

(22) Filed: May 18, 2026

Related U.S. Application Data
(60) Provisional application No. 63/806,875, filed on May 16, 2025.

(51) Int. Cl. G06N 20/00

(52) U.S. Cl. CPC G06N 20/00

(57) ABSTRACT

Examples of the disclosure include at least one non-transitory computer-readable medium storing thereon computer-executable instructions for operating a call-time system that instruct at least one processor to access a plurality of stored donor records for a plurality of potential donors, execute a machine-learning-based model to identify a highest-priority donor from the plurality of potential donors, access a plurality of stored pitch scripts, execute the machine-learning-based model to identify a highest-priority group of pitch scripts for the highest-priority donor, provide a donor record for the highest-priority donor, the donor record including contact information for the highest-priority donor to enable a call with the highest-priority donor, receive a call record indicative of a response from the highest-priority donor to at least one pitch script of the highest-priority group of pitch scripts, and update the machine-learning-based model based on the response from the highest-priority donor to at least one pitch script.

### CROSS-REFERENCE TO RELATED APPLICATIONS

This application claims priority under 35 U.S.C. § 119(e) to U.S. Provisional Application Ser. No. 63/806,875, titled “CALL TIME APPLICATION,” filed on May 16, 2025, which is hereby incorporated by reference in its entirety.

### BACKGROUND

At least one example in accordance with the present disclosure relates generally to a call-time system configured to provide guidance in conducting fundraising calls. In various scenarios, a caller may need to conduct a phone call, a video conference, or other types of real-time telecommunications with each of a series of individuals for a common or related purpose. For example, a representative of a fundraising campaign may call a list of potential donors to make donations to the fundraising campaign. Many representatives fall short at call time. They may ramble, skip the financial ask, misjudge the amount to ask for, or fail to follow up, amongst other shortcomings. Although the representatives may eventually be trained to improve, fundraising dollars may be lost in the meantime.

### SUMMARY

Examples of the methods and systems discussed herein are not limited in application to the details of construction and the arrangement of components set forth in the following description or illustrated in the accompanying drawings. The methods and systems may be capable of implementation in other implementations and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description. References to examples, embodiments, components, elements, or acts of the systems and methods herein referred to in the singular may also embrace examples including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B—that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

Examples of the disclosure include at least one non-transitory computer-readable medium storing thereon computer-executable instructions for operating a call-time system, the computer-executable instructions including instructions that instruct at least one processor to access a plurality of stored donor records for a plurality of potential donors; execute a machine-learning-based model to identify a highest-priority donor from the plurality of potential donors; access a plurality of stored pitch scripts; execute the machine-learning-based model to identify a highest-priority group of pitch scripts for the highest-priority donor; provide a donor record for the highest-priority donor, the donor record including contact information for the highest-priority donor to enable a call with the highest-priority donor; receive a call record indicative of a response from the highest-priority donor to at least one pitch script of the highest-priority group of pitch scripts; and update the machine-learning-based model based on the response from the highest-priority donor to at least one pitch script of the highest-priority group of pitch scripts.

In at least one example, the at least one processor is configured to determine, based on the call record, that a first pitch script of the plurality of stored pitch scripts led to the highest-priority donor making a donation, and wherein updating the machine-learning-based model includes increasing a weight for the first pitch script. In at least one example, the at least one processor is configured to determine, based on the call record, that a first pitch script of the plurality of stored pitch scripts led to the highest-priority donor declining to make a donation, and wherein updating the machine-learning-based model includes decreasing a weight for the first pitch script. In at least one example, the at least one processor is configured to identify the highest-priority group of pitch scripts for the highest-priority donor based on one or more donor interests stored in the donor record for the highest-priority donor, the one or more donor interests being relevant to the highest priority group of pitch scripts.

In at least one example, the call record includes a digital fingerprint of one or more pitch scripts of the highest-priority group of pitch scripts that were presented to the highest-priority donor. In at least one example, the digital fingerprint includes a plurality of user inputs indicative of at least one selection of the one or more pitch scripts and at least one respective selection of a respective response to each pitch script of the one or more pitch scripts. In at least one example, the digital fingerprint includes a timestamped transcript of the call with the highest-priority donor annotated with the plurality of user inputs indicative of the at least one selection of the one or more pitch scripts and the at least one respective selection of the respective response to each pitch script of the one or more pitch scripts.

In at least one example, the at least one processor is further configured to: output, to a caller during the call with the highest-priority donor, a first pitch script of the highest-priority group of pitch scripts; generate a transcript of the caller reading the first pitch script; identify, in real-time, at least one deviation between the transcript and the first pitch script; and output a notification indicative of the at least one deviation between the transcript and the first pitch script. In at least one example, the at least one processor is configured to generate a feedback report for a caller indicative of at least one of a rate at which initiated calls reach a donor, a rate at which calls result in donation pledges, a number of donation pledges per calling session, an average pledge size, or a rate at which pledges are converted to donations. In at least one example, the at least one processor is configured to generate the feedback report over a time scale selected from a list including a single calling session, a single donor list, and a full fundraising campaign.

Examples of the disclosure include a method for operating a call-time system, the method comprising: accessing a plurality of stored donor records for a plurality of potential donors; executing a machine-learning-based model to identify a highest-priority donor from the plurality of potential donors; accessing a plurality of stored pitch scripts; executing the machine-learning-based model to identify a highest-priority group of pitch scripts for the highest-priority donor; providing a donor record for the highest-priority donor, the donor record including contact information for the highest-priority donor to enable a call with the highest-priority donor; receiving a call record indicative of a response from the highest-priority donor to at least one pitch script of the highest-priority group of pitch scripts; and updating the machine-learning-based model based on the response from the highest-priority donor to at least one pitch script of the highest-priority group of pitch scripts.

In at least one example, the method includes determining, based on the call record, that a first pitch script of the plurality of stored pitch scripts led to the highest-priority donor making a donation, and wherein updating the machine-learning-based model includes increasing a weight for the first pitch script. In at least one example, the method includes determining, based on the call record, that a first pitch script of the plurality of stored pitch scripts led to the highest-priority donor declining to make a donation, and wherein updating the machine-learning-based model includes decreasing a weight for the first pitch script. In at least one example, the method includes identifying the highest-priority group of pitch scripts for the highest-priority donor based on one or more donor interests stored in the donor record for the highest-priority donor, the one or more donor interests being relevant to the highest priority group of pitch scripts.

In at least one example, the call record includes a digital fingerprint of one or more pitch scripts of the highest-priority group of pitch scripts that were presented to the highest-priority donor. In at least one example, the digital fingerprint includes a plurality of user inputs indicative of at least one selection of the one or more pitch scripts and at least one respective selection of a respective response to each pitch script of the one or more pitch scripts. In at least one example, the digital fingerprint includes a timestamped transcript of the call with the highest-priority donor annotated with the plurality of user inputs indicative of the at least one selection of the one or more pitch scripts and the at least one respective selection of the respective response to each pitch script of the one or more pitch scripts.

In at least one example, the method includes outputting, to a caller during the call with the highest-priority donor, a first pitch script of the highest-priority group of pitch scripts; generating a transcript of the caller reading the first pitch script; identifying, in real-time, at least one deviation between the transcript and the first pitch script; and outputting a notification indicative of the at least one deviation between the transcript and the first pitch script. In at least one example, the method includes generating a feedback report for a caller indicative of at least one of a rate at which initiated calls reach a donor, a rate at which calls result in donation pledges, a number of donation pledges per calling session, an average pledge size, or a rate at which pledges are converted to donations. In at least one example, the method includes generating the feedback report over a time scale selected from a list including a single calling session, a single donor list, and a full fundraising campaign.

### BRIEF DESCRIPTION OF THE DRAWINGS

Various aspects of at least one example are discussed below with reference to the accompanying figures, which may not be drawn to scale. The figures are included to provide an illustration and a further understanding of the various aspects and examples, and are incorporated in and constitute a part of this specification, but are not intended as a definition of the limits of any particular example. Aspects of an example illustrated in one figure may be combined with aspects of an example illustrated in another figure, even if no one figure illustrates both of the features in a single figure. The drawings, together with the remainder of the specification, serve to explain principles and operations of the described and claimed aspects and examples. In the figures, each identical or substantially similar component that is illustrated in various figures may be represented by a like numeral. For purposes of clarity, not every component may be labeled in every figure. In the figures:

FIG. 1 illustrates a block diagram of a call-time computing system;

FIG. 2 illustrates a process of executing a call-time system;

FIG. 3 illustrates a process of initiating and executing a call; and

FIG. 4 illustrates a process of executing a real-time call-management process.

### DETAILED DESCRIPTION

As discussed above, fundraising campaigns may be established to raise money for various causes, such as political fundraising campaigns, non-profit fundraising campaigns, and so forth. Many fundraising campaigns involve telephone calls from a representative of an organization raising money. Representatives may call potential donors and request that the potential donor make a donation. Calling these potential donors may be referred to as “call-time,” and may take a substantial amount of time and resources to execute.

Many representatives, also referred to as “callers,” as not experts at call-time. Although call-time coaches may be hired to improve representatives'service, this approach has several drawbacks. First, hiring coaches may be expensive. Second, unless a very large number of call-time coaches are hired, there may be a low coach-to-caller ratio. The coach may therefore be unable to provide extensive one-on-one coaching with each caller. Hiring a large number of call-time coaches may be counterproductive, because the costs of hiring the managers may quickly outweigh or severely diminish the net amount of money raised when the managers'costs are subtracted from the amount of money raised.

Third, there are certain types of solutions that no human being—even the most skilled coach—can physically perform. For example, it is impractical for a human being to generate a digital “fingerprint” of actions that a caller takes while on call-time, or to use regression-based machine learning that optimizes a machine-learning model (for example, a logistic-regression-based machine-learning model) based on each call to refine an approach to each subsequent call.

Examples of the disclosure address these and other concerns with an end-to-end, machine-learning-enabled call-time system. The call-time system may facilitate outreach to networks of individuals for various purposes, including, but not limited to, outreach to a network of donors to a fundraising campaign. Although the principles of the disclosure are not limited to fundraising campaigns, examples are provided with reference to a candidate's fundraising campaign for ease of explanation and understanding.

The call-time system may begin with a set of standardized contact-information records for a group of potential donors to contact, and a large set of modular pitch scripts to select from when pitching to the potential donors. Before a call is initiated, a machine-learning-enabled model (for example, a logistic-regression-based machine-learning model) may be used to identify a group of pitch scripts (for example, six pitch scripts) from the large set of modular pitch scripts for the caller to pitch to the potential donor.

During the call, the caller is presented with a contact card for the potential donor and the group of modular pitch scripts to read to the potential donor. The caller reads off a selected pitch script and records the donor's responses to the pitch script. For example, if the selected pitch script asks a yes-or-no question, then the caller may record whether the donor provided an affirmative (“yes”) response or not. In some examples, the call-time system may also provide real-time guidance to the caller based on the donor's responses.

The call-time system may monitor for a gate condition to be met. The gate condition may include a condition or conditions which, if met, prompt the caller to present a financial ask to the potential donor. The gate condition may therefore be optimized to allow that a caller only presents the donor with the financial ask when an optimal point has been reached to make the financial ask, that is, when the donor is most likely to make a donation. Throughout the call, the call-time system may generate a digital fingerprint of the caller's interactions with the donor.

After the call concludes, the caller may record the outcome of the call in a standardized format. For example, if the donor pledged $20, the caller may record this figure and may further record a note to follow-up to confirm that the donor actually makes the $20 donation. This standardized record may further include the digital fingerprint generated by the call-time system. Moreover, this standardized record may be used to train or otherwise refine the machine-learning-enabled model (for example, the logistic-regression-based machine-learning model) that is used to identify a group of pitch scripts for a subsequent call to the next donor. In this manner, the call-time system may in some examples use machine-learning to train based on each individual call.

At various points in time, the call-time system may provide a comprehensive feedback report for the caller. For example, the call-time system may generate weekly coaching reports for the caller. The coaching reports may capture data and trends such as the rate at which calls yield pledges, the rate at which pledges convert to actual donations, the average pledge or donation size, and so forth. These reports may be generated for calls conducted across any time scales or cohorts, such as for a single call, a single day of calling, a single list of donors, a full campaign, and so forth. These reports may also identify general trends and correlate these trends to specific actions. For example, these reports may identify a trend showing that certain pitches tend to yield higher average donations. In some examples, the call-time system may recommend specific changes to pitch language to improve donation pledges.

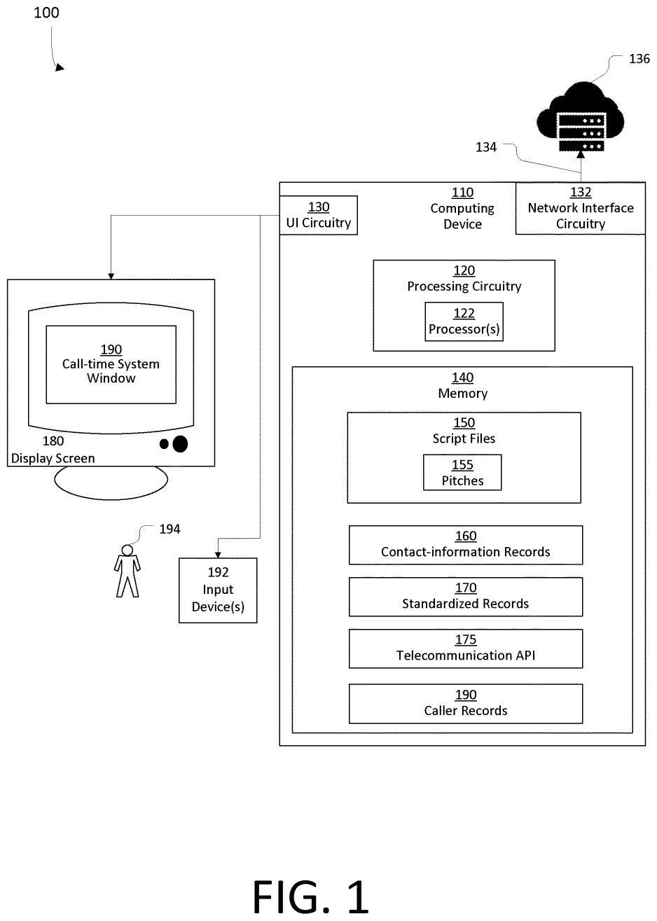

FIG. 1 illustrates a computer system 100 to implement the call-time system according to an example. In some examples, the computer system 100 includes at least one computing device 110, which may be any kind of computing device, such as a personal computer, laptop, workstation, server, enterprise server, tablet, smartphone, router, and so forth. In one example, the computing device 110 is a personal computer or desktop. The computing device 110 includes processing circuitry 120, user interface (UI) circuitry 130, network interface circuitry 132, and memory 140. The computing device 110 may also include various additional features (not illustrated), such as interconnection traces and buses, and so forth. The network interface circuitry 132 may be configured to connect the computing device 110 to an external network 134 (for example, the Internet) with or without connecting wires for accessing a cloud server 136.

The processing circuitry 120 may include one or more processors 122 (“processor 122”) configured to perform operations. The processor 122 may include, for example, a microprocessor, a multi-core microprocessor, a digital signal processor, a field-programmable gate array (FPGA), a system on a chip (SoC), a collection of electronic circuits, a controller, or any combination of the above.

The UI circuitry 130 may include any circuitry configured to enable communication with and connection to one or more input devices 192 (input device 192) and a display screen 180. The UI circuitry 130 may include, for example, a keyboard controller, a mouse controller, a touch controller, a serial bus port and controller, a universal serial bus (USB) port and controller, a wireless controller and antenna (for example, configured to exchange communications structured according to a Bluetooth communication protocol), a sound card module coupled with speech recognition and/or voice-to-text software (for example, for use with a microphone and/or voice controller), a graphics adapter and port, and so forth.

The display screen 180 may be any kind of display screen including, for example, a CRT, LCD screen, LED screen, OLED screen, and so forth. The input device 192 may include a keyboard, keypad, mouse, trackpad, trackball, pointing stick, joystick, touchscreen (for example, embedded within the display screen 180), microphone/voice controller, a scanner device (such as a scanner or a camera), and so forth. In some examples, instead of being external to the computing device 110, the input device 192 and/or the display screen 180 may be embedded within the computing device 110 (for example, a cell phone or tablet with an embedded touchscreen).

A user 194 may interact with the computer system 100 using at least the input device 192 and the display screen 180. For example, the user 194 may be a caller for a fundraising campaign. Accordingly, the user 194 may be alternately referred to as a caller 194. However, it is to be appreciated that the computer system 100 may be used by any number of different callers and, while aspects of the computer system 100 may be adaptable to provide specific information to individual callers, the computer system 100 is not limited to use by any one particular caller.

The storage and/or memory 140 (“memory 140”) may include any kind of memory or storage. In some examples, the memory 140 may include random-access memory (RAM). The memory 140 may store an operating system (OS, not illustrated, for example, a Linux, UNIX, Windows, MacOS, or similar operating system) and various drivers and other applications and software modules, which are configured to be executed on the processing circuitry 120 based on various data. In some examples, the memory 140 may include other information, such as script files 150, donor-information records 160, standardized records 170, a telecommunication application programming interface (API) 175, and one or more caller records 190. The script files 150 may include pitches 155 (or “pitches 155”).

In some examples, the memory 140 may also include a persistent storage portion. The persistent storage portion of the memory 140 may be made of one or more persistent storage devices, such as magnetic disks, flash drives, solid-state storage drives, or other types of storage drives. The persistent storage portion of the memory 140 may be configured to store programs and data even while the computing device 110 is powered off. The OS, the script files 150, the donor-information records 160, the standardized records 170, the telecommunication API 175, the caller records 190, and/or various other applications and drivers may be stored in this persistent storage portion of the memory 140 so that they may be loaded into a system portion of the memory 140 upon a system restart or as needed. When stored in non-transitory form in either the volatile or persistent portion of the memory 140, each of the OS, the script files 150, the donor-information records 160, the standardized records 170, the telecommunication API 175, the caller records 190, and/or various other applications and drivers may form a computer program product. The processing circuitry 120 running one or more applications thus forms a specialized circuit constructed and arranged to carry out the various processes described herein.

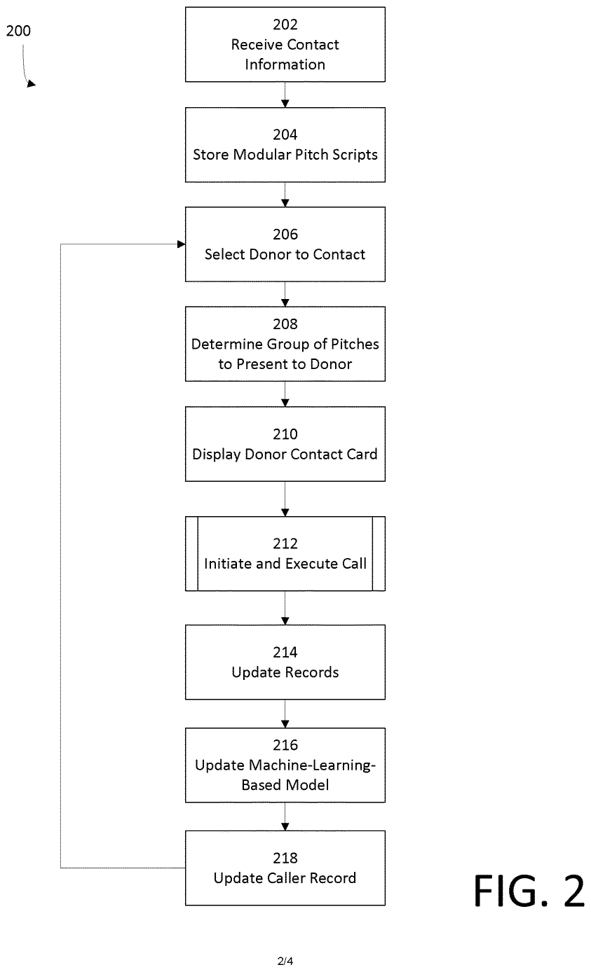

FIG. 2 illustrates a process 200 of operating the computer system 100 according to an example. The process 200 may be executed at least in part by the processing circuitry 120. For example, the processing circuitry 120 may execute the process 200 during a fundraising campaign.

At act 202, the processor 122 receives donor contact information. Donor contact information may include contact information a group of donors that the caller wishes to contact, such as the donor's telephone number, email address, physical address, and so forth. The processing circuitry 120 may standardize the donor contact information to store with the standardized donor-information records 160. The donor-information records 160 may also include other tags and/or information about a respective donor, such as a topics of interest (for example, education access, firearm background checks, and so forth), hobbies, employer, political affiliations ZIP code, age, voting district, donation records (for example, a prior pledge status, an average pledge amount, suggested ask for contribution, any freedom notes, and so forth), title, relationship to the fundraiser, and so forth. In some examples, standardizing the contact information to store in the donor-information records 160 may include converting non-standardized information (for example, from a spreadsheet or text note) into a standardized format. Act 202 may therefore include the processor 122 standardizing a non-standardized input, such as an unstructured spreadsheet, by extracting and categorizing each relevant type of information.

At act 204, the processor 122 stores the script files 150. The script files 150 include scripts to guide the caller 194 during call-time. The script files 150 include the pitches 155, which may include a group of modular pitch scripts. The script files 150 may additionally or alternatively include other information, such as introduction scripts, ask scripts, and so forth. As discussed in greater detail below, the script files 150 may be regularly updated based on feedback information such as the success rate of a particular pitch of the pitches 155.

Modular pitch scripts may include predetermined language for the caller 194 to read to a potential donor during a call. Each of the pitches 155 may relate to a particular topic and be paired with a question. For example, one of the pitches 155 may relate to education funding. In this example, the pitch and paired question may recite, for example, “I'm calling on behalf of Tom H., who is running for city council. One of Tom's priorities is to make sure that every child has access to high-quality education. Is funding our schools a priority to you?” This is just one example, and many different types of pitches exist. In general, a pitch may be a short narrative about a particular topic that may lead up to a question.

In some examples, each of the pitch scripts is paired with a yes-or-no question. The paired questions may be designed such that an answer of “yes” leads to asking the potential donor for a donation. For example, in the foregoing example, an affirmative response (“yes”) to the question asking about school funding may lead to the caller 194 making an ask such as, “That's great! Since funding our schools is a priority to both you and Tom, would you like to make a $50 donation to Tom's campaign?”

Each of the pitches 155 may also be stored with various tags indicating the focus of the respective pitch, such as “education,” “parental rights,” “affordable housing,” and so forth. As discussed in greater detail below, these tags may be correlated to similar tags in the donor-information records 160. For example, a pitch may be tagged with an “education” tag where it relates to a candidate's stance on education, and a donor in the donor-information records 160 may be tagged with an “education” tag where the donor is particularly interested in education policy.

At act 206, the processor 122 selects a donor to connect the caller 194 with. For example, the processor 122 may execute act 206 responsive to the caller 194 providing an input to the computing device 110 indicating that the caller 194 is ready to be connected with a donor. In some examples, sessions may be classified by a session type, such as calls to known donors, calls to new prospects, calls to follow up on unpaid pledges, and thank-you calls.

A donor may be selected from a particular donor list. Donor lists may be stored in the donor-information records 160. In some examples, donor lists may include lists of donors that are related by particular properties; for example, one donor list may be “donors who have previously donated to this candidate's campaign,” another donor list may be “donors who work at Acme Corporation,” another donor list may be “donors who are members of Mothers Against Gun Violence,” and so forth. Although the process 200 may generally be executed in the same manner regardless of session type and donor-list type, these properties may be stored for later analysis, such as by analyzing specific donation properties for donors on a particular donation list.

In some examples, the processor 122 may dynamically determine which donor to next connect the caller 194 with based on a machine-learning-based model. The processor 122 may execute the machine-learning-based model to identify a highest-priority donor to call next based on one or more weighted parameters which may correlate to an individual's likelihood of donating a large contribution. The machine-learning-based model may, in some examples, be used to generate a priority score for each donor on a donor list based on an expected value of the potential donor's prospective donation. Accordingly, a highest-priority donor may be a donor that the machine-learning-based model predicts leads to the highest expected value donation.

For example, the machine-learning-based model may include a logistic regression model that evaluates and weights various parameters. These parameters may include, for example, donation history, such that donors who have made donations before are prioritized over donors who have not made donations before. Furthermore, donors who have donated the largest amounts and/or at the highest frequency may be prioritized over one-time donors. In some examples, the machine-learning-based model may leverage Bayesian statistics to determine which donor to next connect the caller 194 with based not only on donor-specific parameters, but also cohort-level parameters. For example, if members of a particular cohort begin to donate large sums of money, then the machine-learning-based model may more heavily weight cohort membership as a factor in considering which donor to contact next. This may lead to a suggestion that the caller 194 next contact someone that belongs to the cohort in which large sums are being donated.

In some examples, the machine-learning-based model may evaluate current events and/or the topics that the donor is most interested in when determining which donor to contact next. For example, the processor 122 may dynamically monitor real-time news information and may correlate the news information to particular donors to reach out to. If, for example, the news information includes articles regarding a Supreme Court decision that curtails access to low-cost legal counsel, the processor 122 may prioritize donors who are concerned with access to justice and may wish to take action in response to the Supreme Court decision.

For example, the processor 122 may prioritize donors affiliated with the “access2justice. com” domain, where the “access2justice. com” domain is associated with individuals who wish to increase access to low-cost legal counsel. News information is only one example of a dynamically determined parameter that the processor 122 may consider in determining which donor to contact; the processor 122 may prioritize donors based on other information, such as a time of day (for example, certain donors may be more likely to donate earlier in the day), proximity to certain holidays (for example, certain donors may be more likely to donate on Giving Tuesday), proximity to certain events (for example, certain donors may be more likely to donate around April 15^{th} after tax-return refunds are received), and so forth.

At act 208, the processor 122 determines a group of one or more pitches to present to the donor selected at act 206. The group of one or more pitches may be drawn from, and may be a subset of, all of the pitches 155 stored in the script files 150. Whereas the pitches 155 may include all stored pitches, the group of pitches determined at act 208 may be a smaller subset of pitches selected because they are particularly relevant to the donor selected at act 206. For example, whereas the pitches 155 may include dozens or hundreds of pitches, the group of one or more pitches selected at act 208 may include approximately six pitches (although any number of pitches may be selected in other examples).

The processor 122 may utilize a machine-learning-based model to dynamically determine a highest-priority group of pitches based at least on information about the selected donor and/or history data indicative of the effectiveness of one or more of the pitches 155 in previous calls. In some examples, the machine-learning-based model that the processor 122 uses to determine which donor to contact at act 206 is the same model that is used at act 208 to determine which pitches to include.

With respect to the information about the selected donor, the machine-learning-based model may include as parameters various topics that the donor is more or less likely to be interested in. As noted above, each of the pitches 155 and each of the donor-information records 160 may be stored with one or more tags. The processor 122 may select the group of pitches based on which of the pitches 155 have tags matching the tags in the donor-information records 160 for the donor. For example, if the donor is tagged with an “education” tag because education is one of their highest concerns, the processor 122 may select a group of pitches related to education at act 208. The selected group of pitches may cover various topics based on various tags and does not only need to be limited to the issue that the donor is most passionate about.

With respect to the history data indicative of the effectiveness of the pitches 155 in previous calls, the machine-learning-based model may learn based on one or more pitch-success metrics. A pitch may be weighted more heavily based on how successful the pitch has been in the past. For example, if a pitch leads to a donor making a large donation, the processor 122 may increase a weight of the pitch and make the pitch more likely to be suggested in the future. If the pitch leads to the donor declining to make a donation, the processor 122 may decrease the weight of the pitch and make the pitch less likely to be suggested in the future.

A pitch's “success” may be measured by one or more success metrics such as the number of times that the pitch leads to a pledge, or by the average pledge amount that the pitch yields, or by some other metric. In some examples, the success metric may be determined based on a per-pitch basis, or a per-donor basis, or a per-cohort basis, or across all donors. For example, if the donor belongs to a cohort of individuals who share the domain “access2justice. com” in their email addresses, determining the success metric on a per-cohort basis may include determining the success metric for each time that the pitch is presented to individuals with the “access2justice. com” domain.

At act 210, the processor 122 controls the display screen 180 to display a donor contact card. The donor contact card may provide a summary of various information about the donor, such as the donor's name, contact information, occupation, age, topics of interest, and/or any other information that is stored in the donor-information records 160. The donor contact card may remain on the display screen 180 throughout the call to provide the caller 194 with quick, at-a-glance reference information throughout the call.

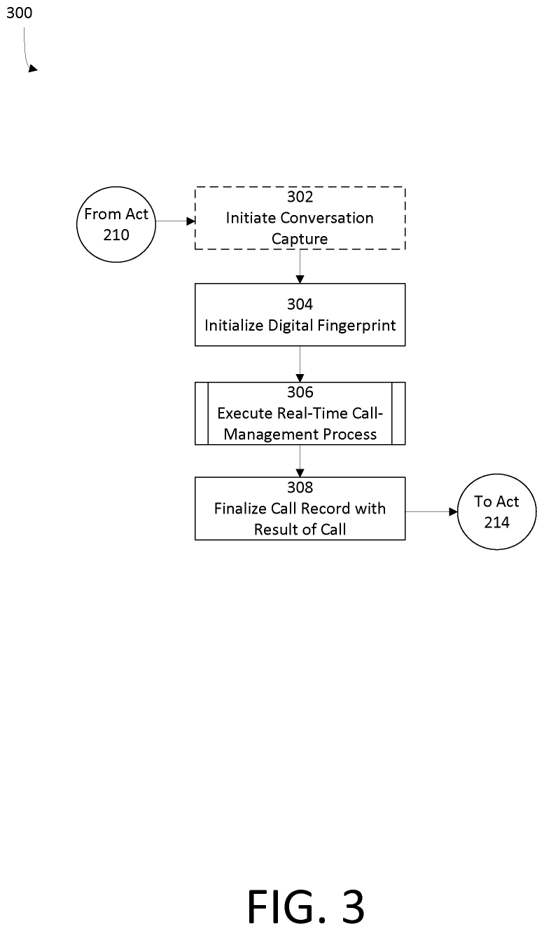

At act 212, the processor 122 initiates and executes the call. For example, the processor 122 may utilize the telecommunication API 175 to initiate a telephone call to the selected donor. In some examples, the processor 122 may first consult a list of one or more conditions which, if met, disallow the connection from being initiated. For example, if the donor is on a do-not-call list or the current time of the donor is outside of a permissible range of times to call, the processor 122 may disallow the call from being initiated. Once a call has been established, the processor 122 may execute a call-time process to help execute the call. An example of act 212 is provided in more detail below in FIG. 3.

At act 214, the processor 122 updates one or more records based on the result of the call. Act 214 may be performed with a finalized call record output by act 212, as discussed below with respect to FIG. 3. For example, the processor 122 may store or update a standardized call-outcome record after the call has been executed and completed at act 212. The record may be stored or updated in the standardized records 170. The standardized call-outcome record may include information indicative of the performance of the script files 150, such as per-pitch success (that is, which of the pitches 155 yield an affirmative “yes” response and which yield a “no” response), a pledge amounts for a particular ask, and so forth. As discussed in greater detail below, the processor 122 may generate and store a digital fingerprint throughout each call that tracks results of various interactions between the caller 194 and the donor.

Act 214 may also include updating the donor-information records 160 for the donor that the caller 194 spoke to. For example, the processor 122 may update the donor-information records 160 to add or remove tags based on the topics that the parties discussed. Suppose, for example, that the donor-information records 160 previously indicated that the donor was most concerned with education. However, during the call, the donor indicates that the donor is now satisfied with the state of education policy but is much more concerned with gun control. The donor-information records 160 may be updated to reflect that the caller 194 should not focus on education policy and should instead focus on gun-control policy when interacting with the donor. For example, if the process 200 were again executed for this particular donor, then act 208 may include omitting education-related pitches from the group of selected pitches and may instead include gun-control-related pitches in the group of selected pitches. These changes may also be propagated to other members of the donor's cohort.

At act 216, the processor 122 updates the machine-learning-based model used at acts 206 and 208 to select a donor and select a group of pitches, respectively. The processor 122 may update the model based on the results of the call executed at act 212, such as by using a finalized call record output by the act 212. For example, if the donor donated a large sum of money, the processor 122 may weight the successful pitches that led to the donation more heavily for future calls. Moreover, in some examples, the donor's cohort may be weighted more heavily at act 206. That is, the processor 122 may be more likely to connect the caller 194 to other donors in the same cohort as the donor who made a large donation in the future.

In various examples, therefore, the machine-learning-based model may be updated based on various parameters obtained during each call. This machine-learning process may occur after each call is completed and before the next call begins. In this manner, every call initiated by the computing device 110 may be based on the most up-to-date information and is thus optimized by the machine-learning model to yield the highest probability of obtaining the highest donation.

This may be the case even if multiple callers are utilizing the computing device 110. For example, a first caller may secure a pledge for a large sum of money from one donor. The machine-learning-based model may immediately update to increase the weight of the pitches that led to that pledge, and may increase the weight of potential donors belonging to the same cohort. A second caller who uses the computing device 110 to execute the process 200 seconds later. Even though the first and second callers may never interact to share information in this short span of time, the second caller may be prompted to contact a member in the same cohort as the large donor and may be presented with the same pitch that yielded the large donation. Accordingly, the process 200 may provide a logistic-regression-based system that dynamically updates weights after each call to provide optimized, up-to-date information for each subsequent call.

At act 218, the processor 122 updates one or more records for the caller 194. For example, the processor 122 may update the caller records 190 based on the results of the call, such as by using a finalized call record output by the act 212. As discussed above, feedback reports may be periodically generated for the caller 194 such that the caller 194 may learn and improve based on their performance. Act 218 may include updating the caller records 190 to indicate whether a donation was secured on the call, an amount of any pledge, which pitches yielded positive versus negative answers, an extent to which the caller 194 deviated from the pitches, and any other information which may be used to provide coaching to the caller 194.

As discussed above, FIG. 3 provides additional details of an example of act 212. FIG. 3 therefore illustrates a process 300 of executing act 212 to initiate and execute a call according to an example. The processor 122 may execute the process 300 while a call between the caller 194 and the donor is ongoing.

At optional act 302, the processor 122 initiates a conversation capture upon beginning the call. For example, the processor 122 may optionally begin recording an audio file of the conversation between the caller 194 and the donor, or may begin to generate a transcript of the conversation. If the donor prefers not to have their portion of the conversation be recorded, no audio or textual recording of the donor's speech is maintained. In some examples, if the donor prefers not to have their portion of the conversation recorded, the caller's 194 speech may still be recorded as an audio file or transcript. In other examples, optional act 302 may not be executed.

At act 304, the processor 122 initializes a digital fingerprint for the call. For example, the processor 122 may initialize a file to store the digital fingerprint. A digital fingerprint may track each action that the caller 194 takes while on the call. For example, the caller 194 may click on prompts that the caller 194 is choosing to read aloud to the donor, and this selection may be stored with a corresponding timestamp in the digital fingerprint. The caller 194 may also click on a button that indicates the donor's response to a question. For example, suppose that the prompt and paired question that the caller 194 is reciting states, “Tom cares about increasing funding to education. Is education also a priority for you this year?” The caller may provide an input to the processor 122 indicative of whether the donor answered “yes” or “no,” which may also be part of the digital fingerprint.

If the conversation is being captured or otherwise monitored as discussed at act 302, certain aspects of what the caller 194 or donor say during the call may also be included in the digital fingerprint. For example, the input device 192 may include a microphone that listens to the caller 194 as the caller 194 speaks. Suppose that the caller 194 begins to read a displayed prompt aloud to the donor. In some examples, the digital fingerprint may include the caller 194 clicking on the prompt to indicate that the caller 194 is reading the prompt. In other examples, the microphone may pick up on the caller 194 reciting the prompt and automatically determine that the caller 194 has read the relevant prompt without the caller 194 needing to select anything. Accordingly, while collecting a digital fingerprint generally involves collecting timestamped information capturing details of the conversation between the caller 194 and the donor, the methods by which the processor 122 obtains this information may differ.

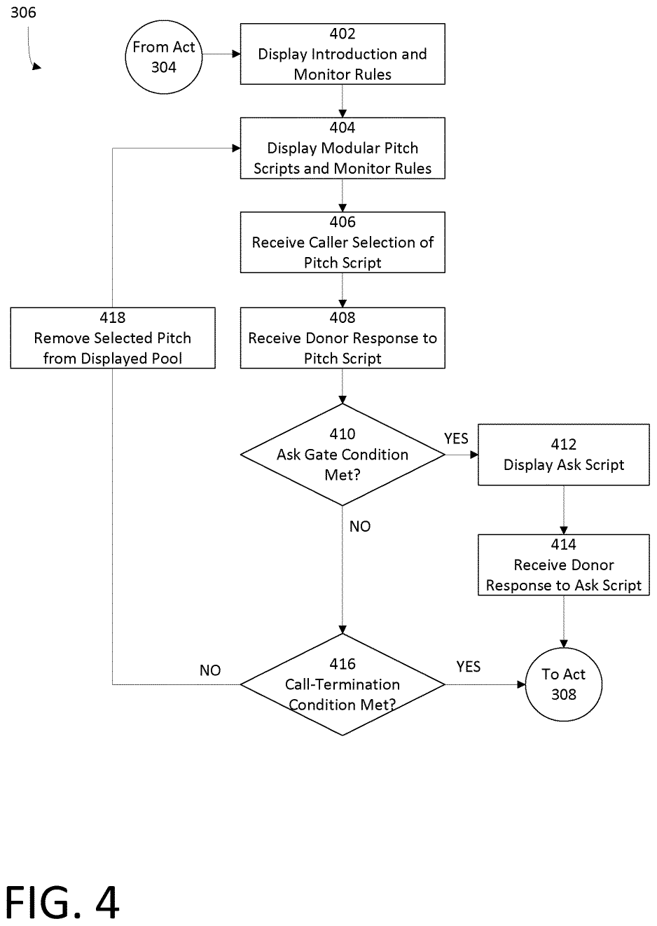

At act 306, the processor 122 executes a real-time call-management process. An example of act 306 is provided in greater detail below with respect to FIG. 4. In general, the processor 122 may guide the caller 194 through various interactions with the donor, such as by suggesting prompts, generating a conversation transcript, generating a timestamped digital footprint, and otherwise providing and receiving data to optimize the present call and subsequent calls.

The processor 122 may also monitor and record any deviations from a script that is presented to the caller 194. These deviations may be stored and, if the deviations lead to better donations, may be used to update the stored pitches 155. If the deviations lead to worse donations, the caller records 190 may be updated such that a coaching summary feedback report presented to the caller 194 suggests that they avoid deviating from the script.

In some examples, the processor 122 may also provide real-time guidance to the caller 194. For example, the processor 122 may detect that the caller 194 has been speaking about a particular topic for too long and should wrap up that line of conversation to move to the next pitch as quickly as possible. As discussed at FIG. 4, act 306 may continue until the call is complete, either because the donor is willing to commit to a donation or is unable to commit to a donation.

At act 308, the processor 122 finalizes a call record with a result of the call. As discussed above, the call record may be used at acts 214-218 for updating records and revising the machine-learning model. The call record may include a summary of all aspects of the call, such as a transcript of the call, a digital fingerprint record including timestamped user inputs indicative of which prompts were selected by the caller 194 and what the donor's response to each prompt was, an indication of any pledge details, an indication of any deviations from the prompts, and any other relevant information captured during the call. In some examples, the call record may synthesize the various records, such as by generating an annotated transcript that annotates the transcript with the pitch scripts selected by the caller 194 and the donor's responses to the pitch scripts.

The process 300 may then end. In examples in which the process 300 is an example of act 212, act 308 may proceed to act 214. As discussed above, acts 214-218 may include updating various records and machine-learning-model weights based on the finalized call record generated at act 308.

FIG. 4 illustrates a real-time call-management process 400 according to an example. As discussed above, the process 400 may be an example of act 306. The processor 122 may execute the process 400 while the caller 194 is interacting with the donor. As discussed above, a digital fingerprint record may be initialized at act 304 prior to executing the process 400. The digital fingerprint record may be updated throughout execution of the process 400. For example, the processor 122 may update the digital fingerprint record with the occurrence of certain events with corresponding timestamps indicating when the event occurs. While every single act that yields changes to the digital fingerprint record will not be described for purposes of brevity, it is to be appreciated that substantially any act that occurs in the execution of the process 400 is eligible for being tracked by the digital fingerprint record.

At act 402, the processor 122 controls the display screen 180 to display an introduction script and monitors one or more compliance rules. The processor 122 may display the introduction script for the caller 194 to read aloud to the donor by way of introduction. The processor 122 may monitor one or more compliance rules to confirm that the caller 194 is abiding by the scripted introduction. For example, the input device 192 may include one or more microphones to monitor what the caller 194 is saying. The processor 122 may generate a transcript of what the caller 194 is saying and may automatically detect deviations from the instruction script. If the caller 194 does deviate, the processor 122 may control the display screen 180 to prompt the caller 194 to return to the introduction script. Other compliance rules may also be implemented, such as instructing the caller 194 not to ask the donor if they have time to speak, or any other compliance rules.

At act 404, the processor 122 controls the display screen 180 to display a group of pitches selected at act 208 and monitors one or more compliance rules. As discussed above, the processor 122 may implement a machine-learning-based model to identify a group of one or more pitches that are most likely to maximize call success, such as by maximizing a pledge amount. For example, the processor 122 may display approximately six pitches on the display screen 180. The processor 122 may monitor one or more compliance rules to confirm that the caller 194 is abiding by the scripted introduction. For example, the input device 192 may include one or more microphones to monitor what the caller 194 is saying. The processor 122 may generate a transcript of what the caller 194 is saying and may automatically detect deviations from the pitch script. If the caller 194 does deviate, the processor 122 may control the display screen 180 to prompt the caller 194 to return to the pitch script. Other compliance rules may also be implemented, such as only asking one question at a time, or limiting periods of the caller 194 talking to no more than fifteen seconds, or any other compliance rules.

At act 406, the processor 122 receives a caller 194 selection of a pitch script from the displayed group of pitches that the caller 194 wishes to read aloud. In one example, the caller 194 may click on a selected pitch to update the digital fingerprint of the interaction and may then read the pitch aloud. The processor 122 may update the digital fingerprint record with an indication of the selected pitch script, a timestamp of when the pitch script was selected, and one or more timestamps capturing how long it takes the caller 194 to read the pitch script.

The processor 122 may implement the compliance rules to detect any deviations. In another example, the processor 122 may use one or more microphones to monitor what the caller 194 is saying and may automatically detect which script the caller 194 has selected. In some examples, the caller 194 may opt for a particular script based on the caller's 194 best judgment as to which script would be most appropriate (for example, based on what the donor has said thus far, such as in response to the introduction displayed at act 402).

In other examples, the processor 122 may monitor the course of the conversation and may use the machine-learning-based model to suggest a particular pitch from the group of pitches. For example, the processor 122 may monitor a transcript of the conversation and/or may monitor notes that the caller 194 inputs about the conversation. This information from the donor may be considered a set of non-standardized inputs or records inasmuch as the donor is speaking in a freeform manner rather than in a structured manner. The processor 122 may, in real-time as the donor is speaking, extract standardized tags from the non-standardized donor input indicative of what topics the donor is concerned with, such as education access, family-planning resources, and so forth.

The processor 122 may use these non-standardized inputs to automatically suggest one or more of the pitches. For example, if the real-time transcript indicates that the donor is speaking extensively about education access and a prompt from the group of prompts relates to education access, it may be advantageous for the caller 194 to select that prompt. This process of selecting one of the pitches based on the non-standardized user inputs may be referred to as converting the non-standardized user inputs into a standardized format, because each of the pitches has structured, predetermined language with specific structured tags. That is, the processor 122 takes in non-structured donor speech as an input, extracts any relevant information or tags, and converts the non-structured information into a suggestion of a standardized output. The processor 122 may then automatically generate a message to the caller 194 containing the standardized output and may notify the caller 194 in real-time of the suggested pitch so that the caller 194 has immediate access to an up-to-date, optimized pitch.

At act 408, the processor 122 receives an input indicative of a donor response to the selected pitch script. For example, if the selected pitch script ended with a yes or no question, then the donor response may include an indication of whether the donor said “yes” or “no” to the question. In some examples, the processor 122 may directly monitor the donor's response (for example, by recording, streaming, or otherwise monitoring audio from the donor). In another example, the caller 194 may provide the input indicative of the donor response. For example, after the caller 194 selects a pitch to read aloud, the processor 122 may control the display screen 180 to display a prompt asking the caller 194 to indicate a donor response to the pitch. In various examples, regardless of how the processor 122 receives the input, the digital fingerprint record may be updated with a timestamped indication of the donor's response.

At act 410, the processor 122 determines whether an ask gate condition(s) has been met. An ask gate condition may include one or more conditions which, if met, “unlock” an ask prompt. In other words, the caller 194 may not be prompted to make a financial ask until the ask gate condition(s) are met. For example, the ask gate condition may, in some examples, only be met if the donor has provided more than one affirmative answer over the course of the call. This may be referred to as a “yes ladder” inasmuch as the caller 194 must “climb” through multiple “yeses” to reach the financial ask. In other examples, other gate conditions may be implemented, such as a minimum time having elapsed on the call, the donor affirmatively stating that they'd like to make a financial contribution, and so forth. The processor 122 may update the digital fingerprint record with timestamped records as gate conditions are met or not met.

If the processor 122 determines that the ask gate condition has been met (410 YES), then the process 400 continues to act 412.

At act 412, the processor 122 controls the display screen 180 to display at least one ask script. In some examples, the processor 122 may display one ask script. In other examples, the processor 122 may display multiple ask scripts for the caller 194 to choose between. The ask script may take various forms, but may ultimately end with a financial ask. In some examples, the financial ask may be open-ended and may not specify a particular dollar figure. In other examples, the financial ask may specify a particular dollar figure. For example, a financial ask may be, “I'm glad to hear that education and environmental justice are important to you. These are also very important to Tom. Would you like to make a donation of $250 to support Tom's candidacy?” The processor 122 may update the digital fingerprint record as the caller 194 reads the ask script to the donor.

At act 414, the processor 122 receives an indication of a donor response to the ask script. For example, the processor 122 may directly monitor the audio of the donor's response, or may monitor a transcript thereof, or may receive a user input from the caller 194 indicative of the donor's response. The donor response may include an indication of whether the donor would like to donate, and if so, how much they would like to donate. The call may then conclude, and the process 400 may return to act 308 to finalize a call record indicative of the result of the call. For example, the call record may include the digital fingerprint record, a transcript (if applicable), an indication of whether the donor is pledging a donation, and so forth.

Returning to act 410, if the processor 122 determines that the ask gate condition has not yet been met (410 NO), then the process 400 continues to act 416.

At act 416, the processor 122 determines whether a call-termination condition(s) is met. Various call-termination conditions exist. For example, a call-termination condition may simply include the caller 194 pressing an “end call” button. In another example, a call-termination condition may include one or more conditions that may be indicative of a situation in which a donor is likely not going to make a donation. Accordingly, it may be advantageous to end the call to save both the donor's time and the caller's 194 time. A call-termination condition may include, for example, a certain amount of time elapsing, or the donor saying “no” to a certain number of pitches, or the donor explicitly or implicitly stating that they are not willing to donate, or any other condition that may be indicative of a call that is unlikely to result in a donation.

If the processor 122 determines that the call-termination condition is met (416 YES), then the caller 194 may be prompted to end the call, such as by prompting the caller 194 to thank the donor for their time. The call may then conclude, and the process 400 may return to act 308 to finalize a call record indicative of the result of the call. For example, the call record may include the digital fingerprint record, a transcript (if applicable), an indication that the donor is not able to pledge a donation, and so forth.

If the processor 122 determines that the call-termination condition is not met (416 NO), then the process 400 continues to act 418.

At act 418, the processor 122 removes the pitch selected at act 406 from the displayed pool of pitches originally displayed at act 404. The caller 194 has already read the selected pitch to the donor, and the pitch has thus already been used. The process 400 may return to act 404. The processor 122 again controls the display screen 180 to display the one or more pitch scripts previously displayed at the previous iteration of act 404, but without the pitch script that was previously selected and is now removed from the pitch pool.

Acts 404-410 and/or 416 may be repeatedly executed until either an ask gate condition is met (410 YES) or a call-termination condition is met (416 YES). Until either condition is met, the processor 122 may monitor the exchange and may update the digital fingerprint record, monitor for compliance rules, and dynamically update the display screen 180 to display feedback and tips to the caller 194 to optimize a likelihood of receiving a donation pledge from the donor.

An example of the process 400 is provided for purposes of explanation. Suppose that the caller 194 is calling on behalf of a candidate for state senate, John Smith. A donor who has been selected for the caller 194 to contact, Jane Doe, is a high-income, politically engaged individual who has previously donated to John Smith's successful run for city council. Moreover, Jane Doe may live in a district that John hopes to win, and John hopes that he can drum up voter support while also soliciting donations. The machine-learning-based model may identify Jane Doe as a high-priority donor to call because she has a high amount of disposable income, she is politically engaged, and she lives in a district that John Smith would like to increase voter support from.

At the start of the call, the processor 122 controls the display screen 180 to display an introduction prompt drawn from Jane Doe's donor profile stored in the donor-information records 160 (act 402). For example, the introduction prompt may read, “John Smith appreciates your previous support of his run for city council and would love your continued support for his run for state senate. Were you happy with John's performance on the city council?”

The processor 122 then controls the display screen 180 to display a group of six prompts selected by the machine-learning-based model for Jane Doe (act 404). For example, Jane Doe's donor information record may indicate that she previously supported John's run for city council because of John's stance on increasing education funding. Accordingly, one of the prompts may read, “During John's tenure on city council, he increased funding to our schools by 15%. Do you think he'd continue to do a great job with education if he's elected to the state senate?”

The processor 122, which is recording a transcript of what the caller 194 is saying, sees in the transcript that the caller 194 is reading the education-related prompt. The processor 122 also receives an indication that the caller 194 has clicked on the education-related prompt. The processor 122 thus receive a caller selection of one of the pitch scripts displayed at act 404 (act 406).

Jane Doe did not consent to being recorded, so no transcript is generated from Jane Doe's affirmative “yes” response indicating that she thinks John will continue to do a great job if he is elected. However, the processor 122 has controlled the display screen 180 to solicit an input from the caller 194 indicating if the donor said “yes” or “no.” The processor 122 receives an input from the caller 194 selecting the “yes” button to memorialize Jane's response.

The processor 122 logs the “yes” response, but determines that the gate condition has not yet been met (act 410—NO), because the ask gate condition indicates that at least two “yeses” need to be received before providing an ask. The processor 122 also determines that no call-termination condition has been met (act 416—NO), however, and thus continues the call. The processor 122 removes the education-related prompt (act 418) but continues to display the remaining five prompts (act 404).

Acts 406-410 may be repeated for the next-highest-priority prompt. For example, Jane Doe's donation records stored in the donor-information records 160 may show that she frequently donates to the campaign of a U.S. senator who is vocally in favor of increased family-planning resources. Accordingly, the next-highest-priority prompt may be, “One of the reasons that John wants to transition from city governance to state governance is to have a greater impact on family-planning resources. Is supporting family planning important to you?” The processor 122 determines, based on a transcript of what the caller 194 is saying, that the caller 194 has read this prompt (act 406).

Jane Doe may answer in the affirmative (act 408) that family planning is important to her. The processor 122 may then determine that the gate condition is met (act 410—YES), because two affirmative responses have been received. The processor 122 may then control the display screen 180 to display an ask script, like “That's great! Your priorities are closely aligned with what John wants to accomplish. Will you donate $200 to support his run for state senate?” (act 412). The processor 122 receives a user input from the caller 194 in which the caller 194 enters, into a standardized field, that Joe Doe has pledged the $200. The caller 194 may then thank Jane Doe and wrap up the call, after which a complete finalized record of the call is stored (act 308).

Examples of the disclosure therefore leverage machine-learning-based models to analyze extremely large sets of data in real-time to maximize fundraising performance. The machine-learning-based models may be updated in real-time as new information is received upon the conclusion of each call (for example, by updating model weights), such as information indicative of pitch success rates. Accordingly, examples of the disclosure enable each individual call to be optimized based on all available data.

In various examples, as discussed above, the processor 122 may monitor the caller's 194 performance in real-time and may provide real-time feedback. In some examples, the processor 122 may additionally or alternatively generate coaching feedback reports based on longer-term performance. For example, the processor 122 may generate a coaching feedback report at the end of every day, or at the end of ever week, or each time the caller 194 has secured another $5,000 in pledges, or based on some other trigger or cadence. The coaching report may include a variety of information to help the caller 194 improve, such as the rate at which dialed calls reach a live person, the rate at which conversations become a pledge, the number of pledges per unit time that the caller 194 is calling donors, the average pledge size, the average rate at which pledges convert to actual donations, the average success metrics for specific pitches, average call-time-duration trends, and so forth. The feedback report may show trends for all of these metrics over various time periods, such as in a session just completed, or for a particular donor list, or for a full campaign, or for a period of time (for example, the past week, the past month, and so forth), or across the most recent $5,000 (or any other amount) raised, and so forth. Examples of the disclosure therefore advantageously provide various coaching metrics over several different time scales using a consistent set of measurements.

Various controllers, such as the processor 122, may execute various operations discussed above. The processor 122 may also execute one or more instructions stored on at least one non-transitory computer-readable medium, which the processor 122 may include and/or be coupled to, which may result in manipulated data. The at least one non-transitory computer-readable medium may include memory and/or storage and may store thereon computer-executable instructions for performing at least a portion of the operations discussed above. In some examples, the processor 122 may include one or more processors or other types of controllers. In one example, the processor 122 is or includes at least one processor. In another example, the processor 122_performs at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one example, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. At least one non-transitory computer-readable medium storing thereon computer-executable instructions for operating a call-time system, the computer-executable instructions including instructions that instruct at least one processor to:
access a plurality of stored donor records for a plurality of potential donors;
execute a machine-learning-based model to identify a highest-priority donor from the plurality of potential donors;
access a plurality of stored pitch scripts;
execute the machine-learning-based model to identify a highest-priority group of pitch scripts for the highest-priority donor;
provide a donor record for the highest-priority donor, the donor record including contact information for the highest-priority donor to enable a call with the highest-priority donor;
receive a call record indicative of a response from the highest-priority donor to at least one pitch script of the highest-priority group of pitch scripts; and
update the machine-learning-based model based on the response from the highest-priority donor to at least one pitch script of the highest-priority group of pitch scripts.

2. The at least one non-transitory computer-readable medium of claim 1, wherein the at least one processor is configured to determine, based on the call record, that a first pitch script of the plurality of stored pitch scripts led to the highest-priority donor making a donation, and wherein updating the machine-learning-based model includes increasing a weight for the first pitch script.

3. The at least one non-transitory computer-readable medium of claim 1, wherein the at least one processor is configured to determine, based on the call record, that a first pitch script of the plurality of stored pitch scripts led to the highest-priority donor declining to make a donation, and wherein updating the machine-learning-based model includes decreasing a weight for the first pitch script.

4. The at least one non-transitory computer-readable medium of claim 1, wherein the at least one processor is configured to identify the highest-priority group of pitch scripts for the highest-priority donor based on one or more donor interests stored in the donor record for the highest-priority donor, the one or more donor interests being relevant to the highest priority group of pitch scripts.

5. The at least one non-transitory computer-readable medium of claim 1, wherein the call record includes a digital fingerprint of one or more pitch scripts of the highest-priority group of pitch scripts that were presented to the highest-priority donor.

6. The at least one non-transitory computer-readable medium of claim 5, wherein the digital fingerprint includes a plurality of user inputs indicative of at least one selection of the one or more pitch scripts and at least one respective selection of a respective response to each pitch script of the one or more pitch scripts.

7. The at least one non-transitory computer-readable medium of claim 6, wherein the digital fingerprint includes a timestamped transcript of the call with the highest-priority donor annotated with the plurality of user inputs indicative of the at least one selection of the one or more pitch scripts and the at least one respective selection of the respective response to each pitch script of the one or more pitch scripts.

8. The at least one non-transitory computer-readable medium of claim 1, wherein the at least one processor is further configured to:
output, to a caller during the call with the highest-priority donor, a first pitch script of the highest-priority group of pitch scripts;
generate a transcript of the caller reading the first pitch script;
identify, in real-time, at least one deviation between the transcript and the first pitch script; and
output a notification indicative of the at least one deviation between the transcript and the first pitch script.

9. The at least one non-transitory computer-readable medium of claim 1, wherein the at least one processor is configured to generate a feedback report for a caller indicative of at least one of a rate at which initiated calls reach a donor, a rate at which calls result in donation pledges, a number of donation pledges per calling session, an average pledge size, or a rate at which pledges are converted to donations.

10. The at least one non-transitory computer-readable medium of claim 9, wherein the at least one processor is configured to generate the feedback report over a time scale selected from a list including a single calling session, a single donor list, and a full fundraising campaign.

11. A method for operating a call-time system, the method comprising:
accessing a plurality of stored donor records for a plurality of potential donors;
executing a machine-learning-based model to identify a highest-priority donor from the plurality of potential donors;
accessing a plurality of stored pitch scripts;
executing the machine-learning-based model to identify a highest-priority group of pitch scripts for the highest-priority donor;
providing a donor record for the highest-priority donor, the donor record including contact information for the highest-priority donor to enable a call with the highest-priority donor;
receiving a call record indicative of a response from the highest-priority donor to at least one pitch script of the highest-priority group of pitch scripts; and
updating the machine-learning-based model based on the response from the highest-priority donor to at least one pitch script of the highest-priority group of pitch scripts.

12. The method of claim 11, further comprising determining, based on the call record, that a first pitch script of the plurality of stored pitch scripts led to the highest-priority donor making a donation, and wherein updating the machine-learning-based model includes increasing a weight for the first pitch script.

13. The method of claim 11, further comprising determining, based on the call record, that a first pitch script of the plurality of stored pitch scripts led to the highest-priority donor declining to make a donation, and wherein updating the machine-learning-based model includes decreasing a weight for the first pitch script.

14. The method of claim 11, further comprising identifying the highest-priority group of pitch scripts for the highest-priority donor based on one or more donor interests stored in the donor record for the highest-priority donor, the one or more donor interests being relevant to the highest priority group of pitch scripts.

15. The method of claim 11, wherein the call record includes a digital fingerprint of one or more pitch scripts of the highest-priority group of pitch scripts that were presented to the highest-priority donor.

16. The method of claim 15, wherein the digital fingerprint includes a plurality of user inputs indicative of at least one selection of the one or more pitch scripts and at least one respective selection of a respective response to each pitch script of the one or more pitch scripts.

17. The method of claim 16, wherein the digital fingerprint includes a timestamped transcript of the call with the highest-priority donor annotated with the plurality of user inputs indicative of the at least one selection of the one or more pitch scripts and the at least one respective selection of the respective response to each pitch script of the one or more pitch scripts.

18. The method of claim 11, further comprising:
outputting, to a caller during the call with the highest-priority donor, a first pitch script of the highest-priority group of pitch scripts;
generating a transcript of the caller reading the first pitch script;
identifying, in real-time, at least one deviation between the transcript and the first pitch script; and
outputting a notification indicative of the at least one deviation between the transcript and the first pitch script.

19. The method of claim 11, further comprising generating a feedback report for a caller indicative of at least one of a rate at which initiated calls reach a donor, a rate at which calls result in donation pledges, a number of donation pledges per calling session, an average pledge size, or a rate at which pledges are converted to donations.

20. The method of claim 19, further comprising generating the feedback report over a time scale selected from a list including a single calling session, a single donor list, and a full fundraising campaign.
